(19) United States
(12) Patent Application Publication
(10) Pub. No.: US 2018/0154361 A1
(43) Pub. Date: Jun. 7, 2018

(54) PARTICLE MANIPULATION SYSTEM WITH OUT-OF-PLANE CHANNEL AND SUBMERGED DICING TRENCH

(71) Applicant: Owl biomedical, Inc., Goleta, CA (US)

(72) Inventors: John S. FOSTER, Santa Barbara, CA (US); Kevin E. SHIELDS, Santa Barbara, CA (US); Mehran R. Hoonejani, Goleta, CA (US); Adam G. Swanson, Carpinteria, CA (US)

(73) Assignee: Owl biomedical, Inc., Goleta, CA (US)

(21) Appl. No.: 15/873,894

(22) Filed: Jan. 17, 2018

Related U.S. Application Data
(63) Continuation-in-part of application No. 15/638,320, filed on Jun. 29, 2017.
Application No. 15/638,320 is a continuation-in-part of application No. 15/159,942, filed on May 20, 2016, now abandoned.
Application No. 15/159,942 is a continuation of application No. 13/998,095, filed on Oct. 1, 2013, now Pat. No. 9,372,144.

(51) Int. Cl. B01L 3/00; F16K 99/00; G01N 15/14; G01N 21/64

(52) U.S. Cl. CPC B01L 3/502761; B01L 2400/0622; B01L 3/502715; B01L 3/502738; B01L 3/502707; G01N 15/1404; G01N 15/1484; G01N 21/6402; G01N 21/6428; G01N 21/6486; B01L 2200/0652; B01L 2300/0627; B01L 2300/0654; B01L 2300/0864; G01N 2201/06113; B01L 2400/0633; G01N 2015/149; G01N 2021/6439; F16K 99/0046

(57) ABSTRACT

A particle manipulation system uses a MEMS-based, microfabricated particle manipulation device which has a sample inlet channel, output channels, and a movable member formed on a substrate. The device may be used to separate a target particle from non-target material in a sample stream. In order to improve the sorter speed, accuracy or yield, the particle manipulation system may also include a microfluidic structure which focuses the target particles in a particular portion of the sample inlet channel. The device may be manufactured using three or more substrates in a wafer stack, and each device may be singulated from the wafer stack using submerged trenches in the middle substrate.

### CROSS REFERENCE TO RELATED APPLICATIONS

This U.S. patent application is a continuation in part from U.S. patent application Ser. No. 15/159942, filed May. 20, 2016, which is a continuation of U.S. patent application Ser. No. 13/998,096, filed. Oct. 1, 2013, now U.S. Pat. No. 9,404,838, each of which is incorporated by reference in its entirety.

### STATEMENT REGARDING FEDERALLY SPONSORED RESEARCH Not applicable.

### STATEMENT REGARDING MICROFICHE APPENDIX Not applicable.

### BACKGROUND

This invention relates to a system and method for manipulating small particles in a microfabricated fluid channel.

Microelectromechanical systems (MEMS) are very small, often moveable structures made on a substrate using surface or bulk lithographic processing techniques, such as those used to manufacture semiconductor devices. MEMS devices may be moveable actuators, sensors, valves, pistons, or switches, for example, with characteristic dimensions of a few microns to hundreds of microns. A moveable MEMS switch, for example, may be used to connect one or more input terminals to one or more output terminals, all microfabricated on a substrate. The actuation means for the moveable switch may be thermal, piezoelectric, electrostatic, or magnetic, for example. MEMS devices may be fabricated on a semiconductor substrate which may manipulate particles passing by the MEMS device in a fluid stream.

In another example, a MEMS devices may be a movable valve, used as a sorting mechanism for sorting various particles from a fluid stream, such as cells from blood. The particles may be transported to the sorting device within the fluid stream enclosed in a microchannel, which flows under pressure. Upon reaching the MEMS sorting device, the sorting device directs the particles of interest such as a blood stem cell, to a separate receptacle, and directs the remainder of the fluid stream to a waste receptacle.

MEMS-based cell sorter systems may have substantial advantages over existing fluorescence-activated cell sorting systems (FACS) known as flow cytometers. Flow cytometers are generally large and expensive systems which sort cells based on a fluorescence signal from a tag affixed to the cell of interest. The cells are diluted and suspended in a sheath fluid, and then separated into individual droplets via rapid decompression through a nozzle. After ejection from a nozzle, the droplets are separated into different bins electrostatically, based on the fluorescence signal from the tag. Among the issues with these systems are cell damage or loss of functionality due to the decompression, difficult and costly sterilization procedures between sample, inability to re-sort sub-populations along different parameters, and substantial training necessary to own, operate and maintain these large, expensive pieces of equipment. For at least these reasons, use of flow cytometers has been restricted to large hospitals and laboratories and the technology has not been accessible to smaller entities.

A number of patents have been granted which are directed to such MEMS-based particle sorting devices. For example, U.S. Pat. No. 6,838,056 (the '056 patent) is directed to a MEMS-based cell sorting device, U.S. Pat. No. 7,264,972 b1 (the '972 patent) is directed to a micromechanical actuator for a MEMS-based cell sorting device. U.S. Pat. No. 7,220,594 (the '594 patent) is directed to optical structures fabricated with a MEMS cell sorting apparatus, and U.S. Pat. No. 7,229,838 (the '838 patent) is directed to an actuation mechanism for operating a MEMS-based particle sorting system. Additionally, U.S. patent application Ser. Nos. 13/374,899 (the '899 application) and 13/374,898 (the '898 application) provide further details of other MEMS designs. Each of these patents ('056, '972, '594 and '838) and patent applications ('898 and '899) is hereby incorporated by reference.

### SUMMARY

One feature of the MEMS-based microfabricated particle sorting system is that the fluid may be confined to small, microfabricated channels formed in a semiconductor substrate throughout the sorting process. The MEMS device may be a valve which separates one or more target particles from other components of a sample stream. The MEMS device may redirect the particle flow from one channel into another channel, when a signal indicates that a target particle is present. This signal may be photons from a fluorescent tag which is affixed to the target particles and excited by laser illumination in an interrogation region upstream of the MEMS device. Thus, the MEMS device may be a particle or cell sorter operating on a fluid sample confined to a microfabricated fluidic channel, but using detection means similar to a FACS flow cytometer. In particular, the '898 application discloses a microfabricated fluidic valve wherein the sample inlet channel, sort channel and waste channel all flow in a plane parallel to the fabrication plane of the microfabricated fluidic valve.

A substantial improvement may be made over the prior art devices by having at least one of the microfabricated fluidic channels route the flow out of the plane of fabrication of the microfabricated valve. A valve with such an architecture has the advantage that the pressure resisting the valve movement is minimized when the valve opens or closes, because the movable member is not required to move a column of fluid out of the way. Instead, the fluid containing the non-target particles may move over and under the movable member to reach the waste channel. Furthermore, the force-generating apparatus may be disposed closer to the movable valve, resulting in higher forces and faster actuation speeds. As a result, the time required to open or close the valve may be much shorter than the prior art valve, improving sorting speed and accuracy. The systems and methods disclosed here may describe such a microfabricated particle sorting device with at least one out-of-plane channel. Furthermore, because of the small size of the features used in such a device, a fluidic focusing mechanism can dramatically improve the performance of the device by urging the particles into a portion of the fluidic channel. By locating the particles, the uncertainty is diminished, which may improve the sort speed and accuracy.

Accordingly, in the systems and methods disclosed here, a micromechanical particle manipulation device may be formed on a surface of a fabrication substrate. The micromechanical particle manipulation device may include a microfabricated, movable member formed on the substrate, and having a first diverting surface, wherein the movable member moves from a first position to a second position in response to a force applied to the movable member, wherein the motion is substantially in a plane parallel to the surface of the substrate. A sample inlet channel may be formed in the substrate and through which a fluid flows, the fluid including target particles and non-target material, wherein the flow in the sample inlet channel is substantially parallel to the surface, a plurality of output channels including a sort output channel into which the microfabricated member diverts the target particles, and a waste output channel into which the non-target material flows, and wherein the flow in waste output channel is substantially orthogonal to the plane, and wherein the waste output channel is located directly below at least a portion of the microfabricated member over at least a portion of its motion.

The system may further comprise a sheath fluid inlet in fluid communication with the sample inlet channel; and a focusing element coupled to the sheath fluid inlet, which is configured to urge the target particles into a particular portion of the sample inlet channel, wherein the focusing element comprises a microfabricated fluid channel with one substantially straight sidewall segment and an adjacent curved sidewall segment, wherein the straight and the curved sidewall segments define a fluid channel segment with a variable channel width. These variable channel width segments may define expansion/contraction cavities within the microfluidic channel, wherein the cavity is defined by the expanding portion followed by the contracting portion.

The particles suspended in the fluid stream may experience hydrodynamic forces as a result of these cavities. The first may be an inertial lift force, which is a combination of shear gradient lift resulting from the flow profile parabolic nature, and wall lift force. In addition, the particles may experience Dean flow drag: which is the drag force exerted on the particles as a result of the secondary dean flow induced by curved streamlines within the cavities. It is possible to balance these two forces by proper selection of the geometrical parameters of height, size, aspect ratio and placement with respect to the expansion/contraction cavities. Accordingly, these two forces may be balanced by introduction of the expansion-contraction cavities described below. This balance has not been achieved heretofore, but it may be achieved using the geometrical ranges set forth here.

The device may also be equipped with a particulate filter. The filter may further include filter barrier elements, wherein filter barrier elements are spaced so as to allow fluid to flow therethrough, but to trap debris and contamination flowing in the sample stream. The filter may also have a transparent layer above the filter elements, which may allow analysis, identification and removal of the contamination. Accordingly, the transparent layer may allow viewing of the material trapped in the filter.

Each of these structures may necessarily be fabricated on a different substrate. The microfabricated valve and microchannels on one substrate, the waste orifice and other structures for liquid handling on another substrate. The valve substrate may have its microchannels enclosed by an overlying transparent layer, allowing the stimulated fluorescence to pass to the detector. Accordingly, to manufacture the structure described herein may require fabrication steps to be carried out on multiple wafers, each of different materials, and one on top of the other, in a multiwafer stack. A methodology is presented herein for efficiently and quickly cleaving each device from the wafer stack.

For complex, multiwafer designs such as this, a novel approach may be used. The novel approach uses laser fracturing on the outermost wafers. However there may be an issue with the laser coupling into the interior wafers to break each layer. For these interior wafers, one may make dedicated features (otherwise known as an “Engineered Substrate”), which will assist the dicing process to follow. This interior wafer may be fabricated with channel cuts (“streets” or “voids”) surrounding each device, so that those layers do not need to be fractured by the radiation process since the material is already removed.

Accordingly, disclosed here is a method for singulating a micromechanical device fabricated on a multi-substrate wafer stack. The wafer stack may have two outer substrates and at least one inner substrate. The method may include forming a microfabricated structure on the inner substrate, forming a void in the inner substrate completely surrounding the microfabricated structure, the void forming a perimeter around the microfabricated structure, separating the individual microfabricated structures by dividing the outer substrates into die.

The product of this method may be a micromechanical device, formed on a wafer stack, the wafer stack having two outer substrates and at least one inner substrate. The device may include a microfabricated structure formed on at least the one inner substrate, wherein the microfabricated structure is surrounded by a continuous void in the at least one inner substrate, and two outer substrates adhered to the inner substrate, the perimeter of the two outer substrates overhanging and extending beyond the void in the at least one inner substrate. Before separation, the devices may be disposed on a multiwafer stack. The wafer stack may have two outer substrates and at least one inner substrate. The stack may further have a plurality of microfabricated structures on the inner substrate, a plurality of voids in the inner substrate completely surrounding the microfabricated structures, forming a perimeter void around each of the microfabricated structures, and two outer substrates adhered to the inner substrate with microfabricated structure and void, wherein the two outer substrates overhang the voids in the inner substrate.

These and other features and advantages are described in, or are apparent from, the following detailed description.

### BRIEF DESCRIPTION OF THE DRAWINGS

Various exemplary details are described with reference to the following figures, wherein:

FIG. 1 is a simplified plan view of a microfabricated particle sorting system in the quiescent (no sort) position;

FIG. 2 is a simplified plan view of a microfabricated particle sorting system in the actuated (sort) position;

FIG. 3a is a simplified plan view of a microfabricated particle sorting system showing the field of view of the detector, with the microfluidic valve in the quiescent (no sort) position; FIG. 3b is a simplified illustration of a microfabricated particle sorting system showing the field of view of the detector, with the microfluidic valve in the actuated (sort) position;

FIG. 4a is a simplified cross sectional view of a microfabricated particle sorting system in the actuated (sort) position, showing the flow of the sample stream into the sort channel which is in the same plane as the sample inlet channel; FIG. 4b is a simplified cross sectional view of a microfabricated particle sorting system in the quiescent (no sort) position, showing the flow of the sample stream into the waste channel which is not in the same plane as the sample inlet channel; FIG. 4c is a simplified cross sectional view of a microfabricated particle sorting system in the quiescent (no sort) position, showing the flow of the sample stream into the waste channel which is not in the same plane as the sample inlet channel, wherein the sample stream flows around the top and the bottom of the diverter;

FIG. 5 is a simplified plan view of a microfabricated particle sorting system in the quiescent (no sort) position, showing the stationary magnetically permeable feature;

FIG. 6 is a plan view of the actuation mechanism for the microfabricated particle sorting system, showing the functioning of the external magnetic field in combination with the stationary magnetically permeable feature;

FIG. 7 is a plan view of the actuation mechanism for the microfabricated particle sorting system, showing the functioning of the external magnetic field in combination with the stationary magnetically permeable feature, in the actuated (sort) position;

FIG. 8 is a plan view of the microfabricated particle sorting system in combination with a hydrodynamic focusing manifold;

FIG. 9 is simplified schematic diagram of the novel variable cross section focusing channel;

FIG. 10 is simplified schematic diagram of the forces operating in the novel variable cross section focusing channel; (a) shows the contours of the device and the streamlines therein; (b) shows the cross sectional dimensions and the flow direction; (c) shows the stable regions in the flow; and (d) shows the hydrodynamic forces acting on the particles;

FIG. 11 is a cross sectional view of a microfabricated particle filter that may be used with the microfabricated particle manipulation device described here;

FIG. 12 is a plan view of a microfabricated particle filter that may be used with the microfabricated particle manipulation device described here;

FIG. 13 is a simplified schematic illustration showing the architecture of the microfabricated particle manipulation device including a transparent top substrate, silicon middle substrate and silicon bottom substrate, and their relationship to the electromagnet;

FIG. 14 is a simplified plan view of the first substrate and the second, intermediate substrate in one step during fabrication, wherein the voids or streets are formed between the individual device;

FIG. 15 is a simplified cross sectional diagram showing a multiwafer stack just prior to singulation; and

FIG. 16 simplified cross sectional diagram showing a single, diced, separate microfabricate particle manipulation device.

It should be understood that the drawings are not necessarily to scale, and that like numbers may refer to like features.

### DETAILED DESCRIPTION

The system described herein is a particle sorting system which may make use of the microchannel architecture of a MEMS particle manipulation system. More generally, the systems and methods describe a particle manipulation system with a sample inlet channel and a plurality of output channels, wherein at least one of the plurality of output channels is disposed in a different plane than the sample inlet channel. In addition, these microfluidic devices are made with very tight tolerances and narrow separations, which can benefit significantly from focusing the suspended particles into a smaller portion of the flow channel. As will be made clear in the discussion below, this architecture has some significant advantages relative to the prior art.

In the figures discussed below, similar reference numbers are intended to refer to similar structures, and the structures are illustrated at various levels of detail to give a clear view of the important features of this novel device. It should be understood that these drawings do not necessarily depict the structures to scale, and that directional designations such as “top,” “bottom,” “upper,” “lower,” “left” and “right” are arbitrary, as the device may be constructed and operated in any particular orientation. In particular, it should be understood that the designations “sort” and “waste” are interchangeable, as they only refer to different populations of particles, and which population is called the “target” or “sort” population is arbitrary.

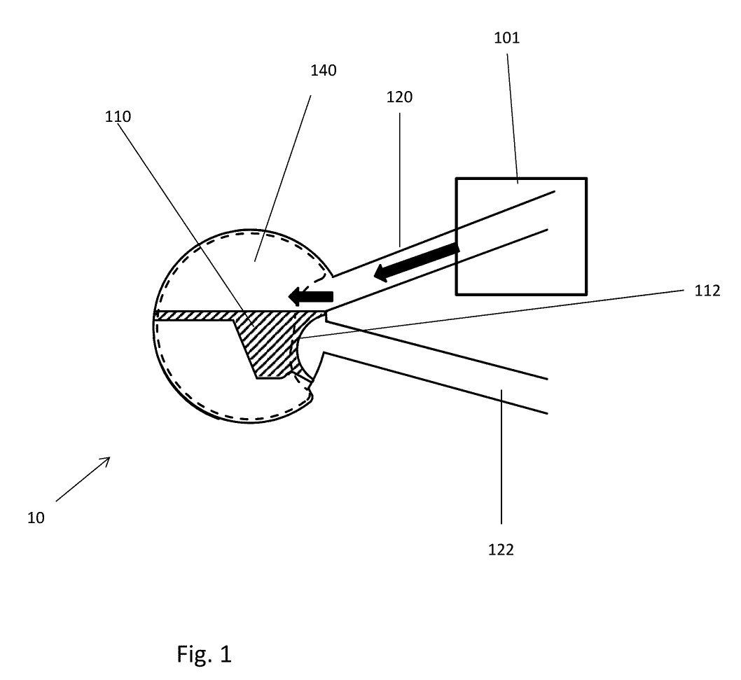

FIG. 1 is a plan view illustration of the novel microfabricated fluidic device 10 in the quiescent (un-actuated) position. The device 10 may include a microfabricated fluidic valve or movable member 110 and a number of microfabricated fluidic channels 120, 122 and 140. The fluidic valve 110 and microfabricated fluidic channels 120, 122 and 140 may be formed in a suitable substrate, such as a silicon substrate, using MEMS lithographic fabrication techniques as described in greater detail below. The fabrication substrate may have a fabrication plane in which the device is formed and in which the movable member 110 moves.

A sample stream may be introduced to the microfabricated fluidic valve 110 by a sample inlet channel 120. The sample stream may contain a mixture of particles, including at least one desired, target particle and a number of other undesired, nontarget materials. The particles may be suspended in a fluid. For example, the target particle may be a biological material such as a stem cell, a cancer cell, a zygote, a protein, a T-cell, a bacteria, a component of blood, a DNA fragment, for example, suspended in a buffer fluid such as saline. The sample inlet channel 120 may be formed in the same fabrication plane as the valve 110, such that the flow of the fluid is substantially in that plane. The motion of the valve 110 is also within this fabrication plane. The decision to sort/save or dispose/waste a given particle may be based on any number of distinguishing signals. In one exemplary embodiment, the decision is based on a fluorescence signal emitted by the particle, based on a fluorescent tag affixed to the particle and excited by an illuminating laser. The distinction between the target particles and non-target material may be made in laser interrogation region 101. There may be a plurality of laser interrogation regions 101, although only one is shown in FIG. 1. Details as to this detection mechanism are well known in the literature, and further discussed below with respect to FIG. 21. However, other sorts of distinguishing signals may be anticipated, including scattered light or side scattered light which may be based on the morphology of a particle, or any number of mechanical, chemical, electric or magnetic effects that can identify a particle as being either a target particle, and thus sorted or saved, or an nontarget particle and thus rejected or otherwise disposed of.

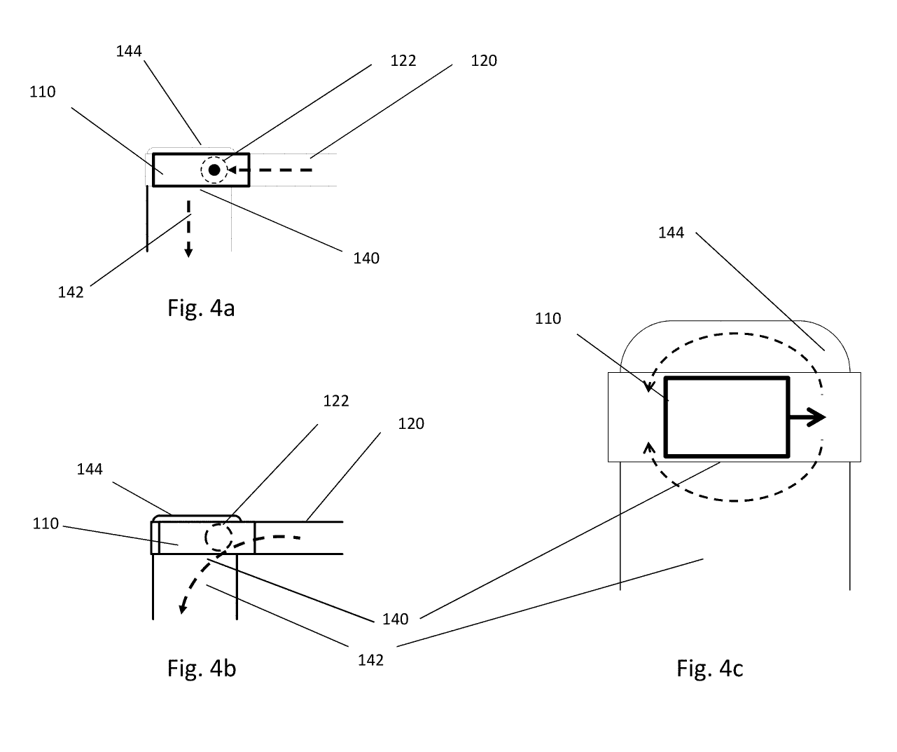

With the valve 110 in the position shown, the input stream passes unimpeded to an output orifice and channel 140 which is out of the plane of the sample inlet channel 120, and thus out of the fabrication plane of the device 10. That is, the flow is from the sample inlet channel 120 to the output orifice 140, from which it flows substantially vertically, and thus orthogonally to the sample inlet channel 120. This output orifice 140 leads to an out-of-plane channel that may be perpendicular to the plane of the paper showing FIG. 1, and depicted in the cross sectional views of FIGS. 4a-4c. More generally, the output channel 140 is not parallel to the plane of the sample inlet channel 120 or sort channel 122, or the fabrication plane of the movable member 110.

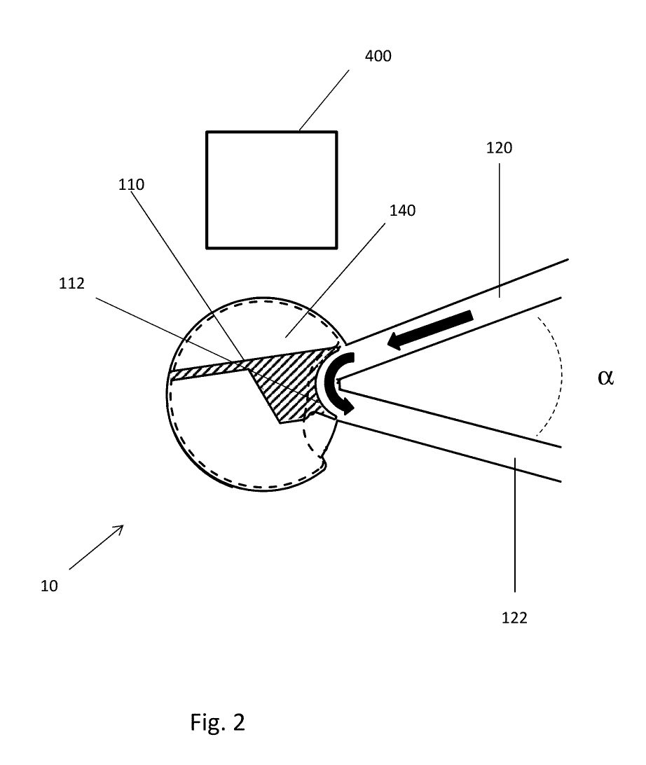

The output orifice 140 may be a hole formed in the fabrication substrate, or in a covering substrate that is bonded to the fabrication substrate. A relieved area above and below the sorting valve or movable member 110 allows fluid to flow above and below the movable member 110 to output orifice 140, and shown in more detail in FIGS. 4a-4c. Further, the valve 110 may have a curved diverting surface 112 which can redirect the flow of the input stream into a sort output stream, as described next with respect to FIG. 2. The contour of the orifice 140 may be such that it overlaps some, but not all, of the sample inlet channel 120 and sort channel 122. By having the contour 112 overlap the sample inlet channel, and with relieved areas described above, a route exists for the input stream to flow directly into the waste orifice 140 when the movable member or valve 110 is in the un-actuated waste position.

FIG. 2 is a plan view of the microfabricated device 10 in the actuated position. In this position, the movable member or valve 110 is deflected upward into the position shown in FIG. 2. The diverting surface 112 is a sorting contour which redirects the flow of the sample inlet channel 120 into the sort output channel 122. The output sort channel 122 may lie in substantially the same plane as the sample inlet channel 120, such that the flow within the sort channel 122 is also in substantially the same plane as the flow within the sample inlet channel 120. There may be an angle □□ between the sample inlet channel 120 and the sort channel 122, This angle may be any value up to about 90 degrees. Actuation of movable member 110 may arise from a force from force-generating apparatus 400, shown generically in FIG. 2. In some embodiments, force-generating apparatus may be an electromagnet, however, it should be understood that force-generating apparatus may also be electrostatic, piezoelectric, or some other means to exert a force on movable member 110, causing it to move from a first position (FIG. 1) to a second position (FIG. 2).

More generally , the micromechanical particle manipulation device shown in FIGS. 1 and 2 may be formed on a surface of a fabrication substrate, wherein the micromechanical particle manipulation device may include a microfabricated, movable member 110 having a first diverting surface 112, wherein the movable member 110 moves from a first position to a second position in response to a force applied to the movable member, wherein the motion is substantially in a plane parallel to the surface, a sample inlet channel 120 formed in the substrate and through which a fluid flows, the fluid including one or more target particles and non-target material, wherein the flow in the sample inlet channel is substantially parallel to the surface, and a plurality of output channels 122, 140 into which the microfabricated member diverts the fluid, and wherein the flow in at least one of the output channels 140 is not parallel to the plane, and wherein at least one output channel 140 is located directly below at least a portion of the movable member 110 over at least a portion of its motion.

In one embodiment, the diverting surface 112 may be nearly tangent to the input flow direction as well as the sort output flow direction, and the slope may vary smoothly between these tangent lines. In this embodiment, the moving mass of the stream has a momentum which is smoothly shifted from the input direction to the output direction, and thus if the target particles are biological cells, a minimum of force is delivered to the particles. As shown in FIGS. 1 and 2, the micromechanical particle manipulation device 10 has a first diverting surface 112 with a smoothly curved shape, wherein the surface which is substantially tangent to the direction of flow in the sample inlet channel at one point on the shape and substantially tangent to the direction of flow of a first output channel at a second point on the shape, wherein the first diverting surface diverts flow from the sample inlet channel into the first output channel when the movable member 110 is in the first position, and allows the flow into a second output channel in the second position.

In other embodiments, the overall shape of the diverter 112 may be circular, triangular, trapezoidal, parabolic, or v-shaped for example, but the diverter serves in all cases to direct the flow from the sample inlet channel to another channel.

It should be understood that although channel 122 is referred to as the “sort channel” and orifice 140 is referred to as the “waste orifice”, these terms can be interchanged such that the sort stream is directed into the waste orifice 140 and the waste stream is directed into channel 122, without any loss of generality. Similarly, the “sample inlet channel” 120 and “sort channel” 122 may be reversed. The terms used to designate the three channels are arbitrary, but the inlet stream may be diverted by the valve 110 into either of two separate directions, at least one of which does not lie in the same plane as the other two. The term “substantially” when used in reference to an angular direction, i.e. substantially tangent or substantially vertical, should be understood to mean within 15 degrees of the referenced direction. For example, “substantially orthogonal” to a line should be understood to mean from about 75 degrees to about 105 degrees from the line.

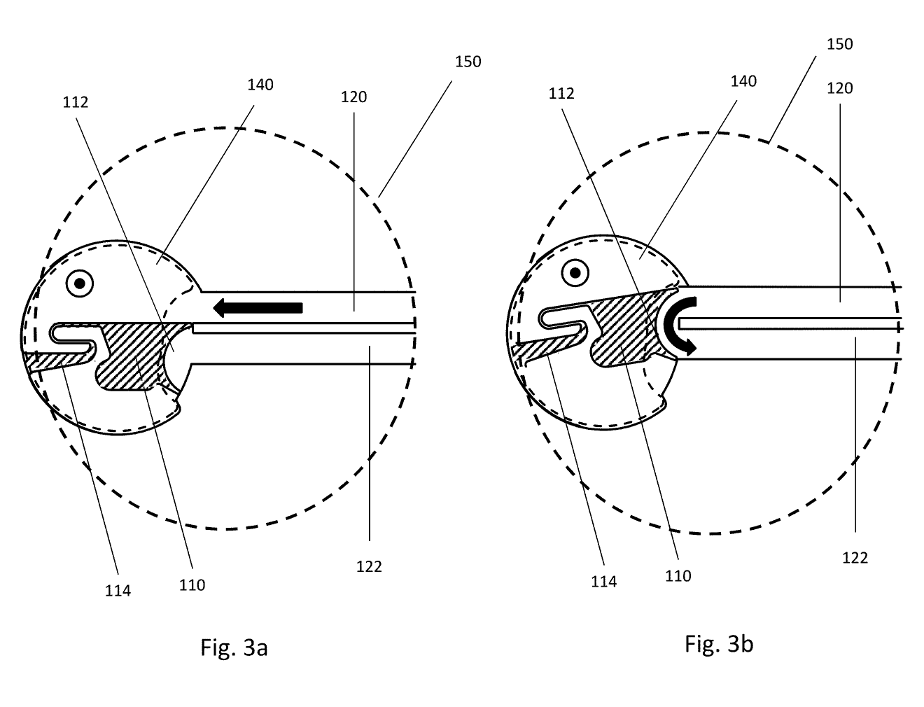

FIGS. 3a and 3b illustrate an embodiment wherein the angle □□ between the sample inlet channel 120 and the sort channel 122 is approximately zero degrees. Accordingly, the sort channel 122 is essentially antiparallel to the sample inlet channel 120, such that the flow is from right to left in the sample inlet channel 120. With valve 110 in the un-actuated, quiescent position shown in FIG. 3a, the inlet stream flows straight to the waste orifice 140 and vertically out of the device 10.

In FIG. 3b, the valve 110 is in the actuated, sort position. In this position, the flow is turned around by the diverting surface 112 of the valve 110 and into the antiparallel sort channel 122. This configuration may have an advantage in that the field of view of the detector 150 covers both the sample inlet channel 120 and the sort channel 122. Thus a single set of detection optics may be used to detect the passage of a target particle through the respective channels. It may also be advantageous to minimize the distance between the detection region and the valve 110, in order to minimize the timing uncertainty in the opening and closing of the valve.

The movable member or valve 110 may be attached to the substrate with a flexible spring 114. The spring may be a narrow isthmus of substrate material. In the example set forth above, the substrate material may be single crystal silicon, which is known for its outstanding mechanical properties, such as its strength, low residual stress and resistance to creep. With proper doping, the material can also be made to be sufficiently conductive so as to avoid charge build up on any portion of the device, which might otherwise interfere with its movement. The spring may have a serpentine shape as shown, having a width of about 1 micron to about 10 microns and a spring constant of between about 10 N/m and 100 N/m, and preferably about 40 N/m

FIGS. 4a, 4b, 4c are cross sectional views illustrating the operation of the out-of-plane waste channel 140. FIG. 4c is slightly enlarged relative to FIGS. 4a and 4b, in order to show detail of the flow around the movable member 110 and into the waste channel 142 through waste orifice 140. In this embodiment, the waste channel 142 is vertical, substantially orthogonal to the inlet stream 120 and sort stream 122. It should be understood that other embodiments are possible other than orthogonal, but in any event, the flow into waste channel 142 is out of the plane of the flow in the sample inlet channel 120 and/or sort channel 122. As shown in FIG. 4a, with the valve in the sort, actuated position, the inlet stream and target particle may flow into the sort stream, which in FIG. 4a is out of the paper, and the waste orifice 140 is largely, though not completely, blocked by the movable member 110. The area 144 (shown more clearly in FIG. 4c) on top of the valve or movable member 110 may be relieved to provide clearance for this flow.

When the valve or movable member 110 is un-actuated as in FIG. 4b, the flow of the sample inlet channel 120 may flow directly into the waste channel 142 by going over, around or by the movable member or valve 110. The area 144 on top of the valve or movable member 110 may be relieved to provide clearance for this flow. The relieved area 144 is shown in greater detail in the enlarged FIG. 4c. Thus, when the movable member 110 is un-actuated, the flow will be sent directly to the waste channel. When the movable member 110 is actuated, most of the fluid will be directed to the sort channel, although liquid may still flow over and under the movable member 110.

Thus, the purpose of providing flow both under and over the movable member 110 is to reduce the fluid pressure produced by the actuator motion in the region behind the valve or movable member 110. In other words, the purpose is to provide as short a path as possible between the high pressure region in front of the valve 110 and the low pressure region behind the valve. This allows the valve to operate with little pressure resisting its motion. As a result, the movable valve 110 shown in FIGS. 1-4c may be substantially faster than valves which have all channels disposed in the same plane.

Another advantage of the vertical waste channel 142 is that by positioning it directly underneath a stationary permeable feature 130 and movable permeable feature 116, the magnetic gap between the permeable features 116 and 130 can be narrower than if the fluidic channel went between them. The narrower gap enables higher forces and thus faster actuation compared to prior art designs. A description of the magnetic components and the magnetic actuation mechanism will be given next, and the advantages of the out-of-plane channel architecture will be apparent.

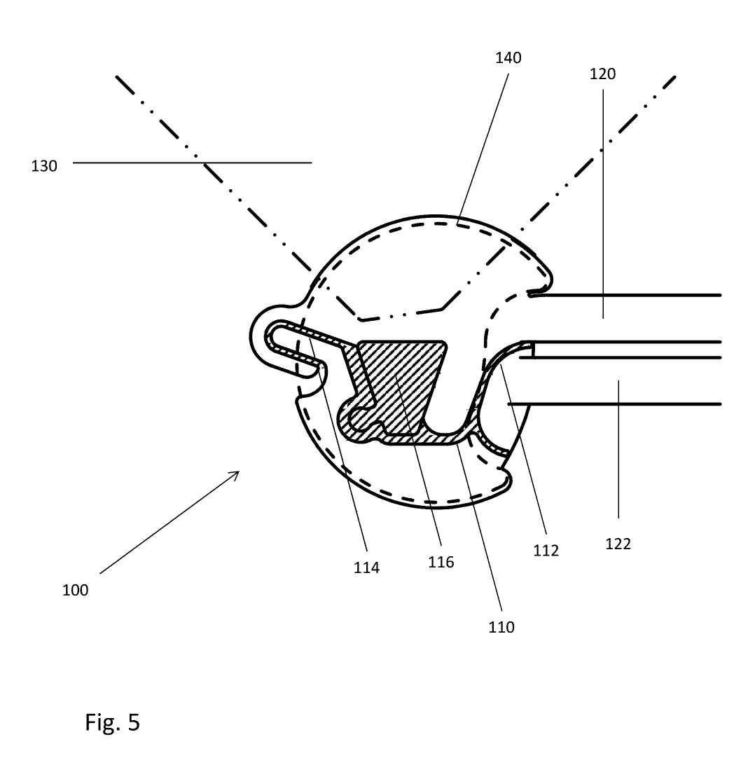

FIG. 5 is a plan view of another exemplary embodiment of device 100 of the device 10, showing the disposition of a stationary permeable feature 130 and further detail of the movable member 110. In this embodiment, the movable member 110 may include the diverting surface 112, the flexible hinge or spring 114, and a separate area 116 circumscribed but inside the line corresponding to movable member 110. This area 116 may be inlaid with a permeable magnetic material such as nickel-iron permalloy, and may function as described further below.

A magnetically permeable material should be understood to mean any material which is capable of supporting the formation of a magnetic field within itself. In other words, the permeability of a material is the degree of magnetization that the material obtains in response to an applied magnetic field.

The terms “permeable material” or “material with high magnetic permeability” as used herein should be understood to be a material with a permeability which is large compared to the permeability of air or vacuum. That is, a permeable material or material with high magnetic permeability is a material with a relative permeability (compared to air or vacuum) of at least about 100, that is, 100 times the permeability of air or vacuum which is about 1.26×10⁻⁶ H·m⁻1. There are many examples of permeable materials, including chromium (Cr), cobalt (Co), nickel (Ni) and iron (Fe) alloys. One popular permeable material is known as Permalloy, which has a composition of between about 60% and about 90% Ni and 40% and 10% iron. The most common composition is 80% Ni and 20% Fe, which has a relative permeability of about 8,000.

It is well known from magnetostatics that permeable materials are drawn into areas wherein the lines of magnetic flux are concentrated, in order to lower the reluctance of the path provided by the permeable material to the flux. Accordingly, a gradient in the magnetic field urges the motion of the movable member 110 because of the presence of inlaid permeable material 116, towards areas having a high concentration of magnetic flux. That is, the movable member 110 with inlaid permeable material 116 will be drawn in the direction of positive gradient in magnetic flux.

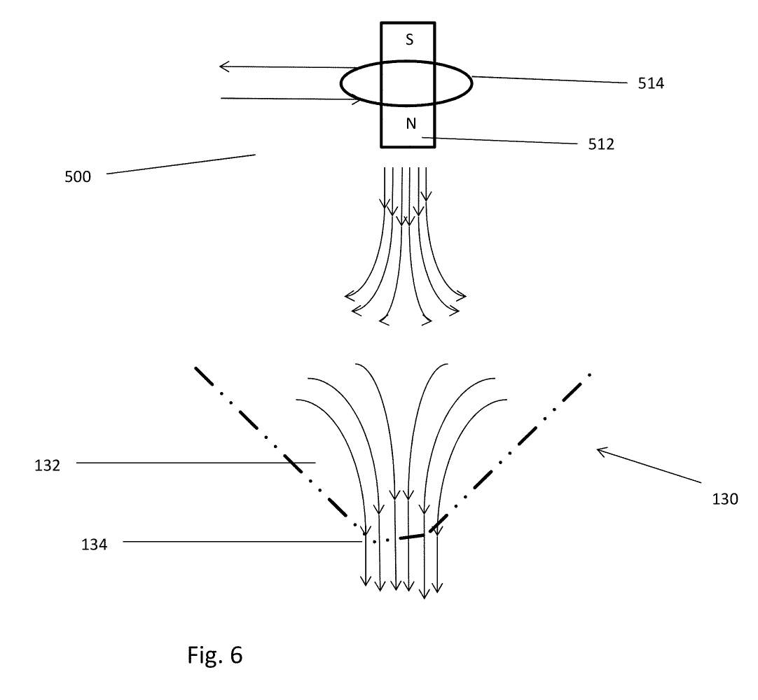

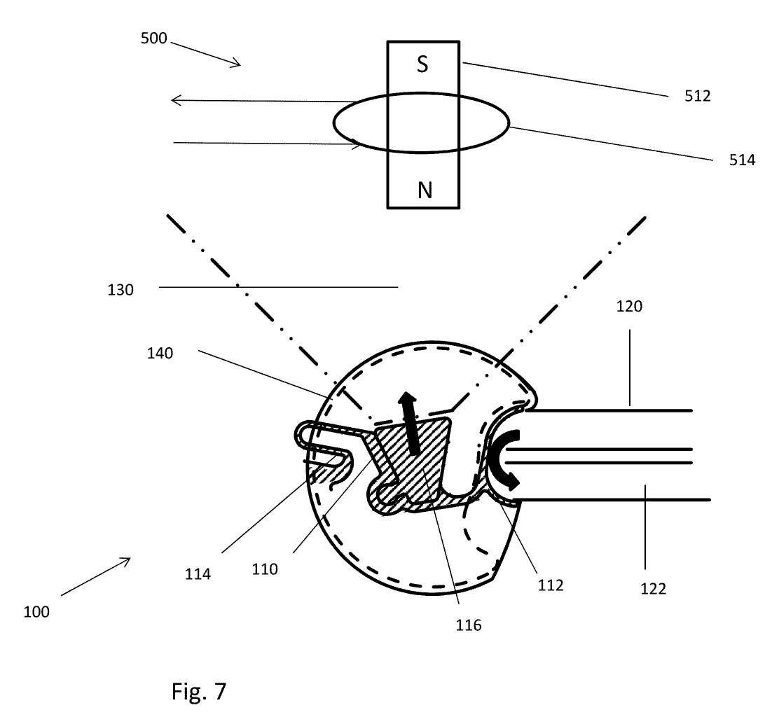

An external source of magnetic field lines of flux may be provided outside the device 100, as shown in FIG. 6. This source may be an electromagnet 500. The electromagnet 500 may include a permeable core 512 around which a conductor 514 is wound. The wound conductor or coil 514 and core 512 generate a magnetic field which exits the pole of the magnet, diverges, and returns to the opposite pole, as is well known from electromagnetism. Accordingly, the movable member 110 is generally drawn toward the pole of the electromagnet 500 as shown in FIG. 7.

However, the performance of the device 100 can be improved by the use of a stationary permeable feature 130. The term “stationary feature” should be understood to mean a feature which is affixed to the substrate and does not move relative to the substrate, unlike movable member or valve 110. A stationary permeable feature 130 may be shaped to collect these diverging lines of flux and refocus them in an area directly adjacent to the movable member 110 with inlaid permeable material. The stationary permeable feature 130 may have an expansive region 132 with a narrower throat 134. The lines of flux are collected in the expansive region 132 and focused into and out of the narrow throat area 134. Accordingly, the density of flux lines in the throat area 134 is substantially higher than it would be in the absence of the stationary permeable feature 130. Thus, use of the stationary permeable feature 130 though optional, allows a higher force, faster actuation, and reduces the need for the electromagnet 500 to be in close proximity to the device 10. From the narrow throat area 134, the field lines exit the permeable material and return to the opposite magnetic pole of the external source 500. But because of the high concentration of field lines in throat area 134, the permeable material 116 inlaid into movable member 110 may be drawn toward the stationary permeable feature 130, bringing the rest of movable member with it.

When the electromagnet is quiescent, and no current is being supplied to coil 514, the restoring force of spring 114 causes the movable member 110 to be in the “closed” or “waste” position. In this position, the inlet stream passes unimpeded through the device 100 to the waste channel 140. This position is shown in FIG. 5. When the electromagnet 500 is activated, and a current is applied through coil 514, a magnetic field arises in the core 512 and exits the pole of the core 512. These lines of flux are collected and focused by the stationary permeable feature 130 and focused in the region directly adjacent to the throat 134. As mentioned previously, the permeable portion 116 of the movable member 110 is drawn toward the throat 134, thus moving the movable member 110 and diverting surface 112 such that the inlet stream in sample inlet channel 120 is redirected to the output or sort channel 122. This position is shown in FIG. 7.

Permalloy may be used to create the permeable features 116 and 130, although it should be understood that other permeable materials may also be used. Permalloy is a well known material that lends itself to MEMS lithographic fabrication techniques. A method for making the permeable features 116 and 130 is described further below.

As mentioned previously, having the waste channel 140 and 142 directly beneath the movable member or valve 110 allows the movable permeable feature 116 to be disposed much closer to the stationary permeable feature 130. If instead the waste channel were in the same plane, this gap would have to be at least large enough to accommodate the waste channel, along with associated tolerances. As a result, actuation forces are higher and valve opening and closing times are much shorter. This in turn corresponds to either faster sorting or better sorting accuracy, or both.

With the use of the electromagnetic actuation technique described above, actuation times on the order of 10 microseconds can be realized. Accordingly, the particle sorting device is capable of sorting particles at rates in excess of 50 kHz or higher, assuming 10 microseconds required to pull the actuator in, and 10 microseconds required to return it to the as-manufactured position.

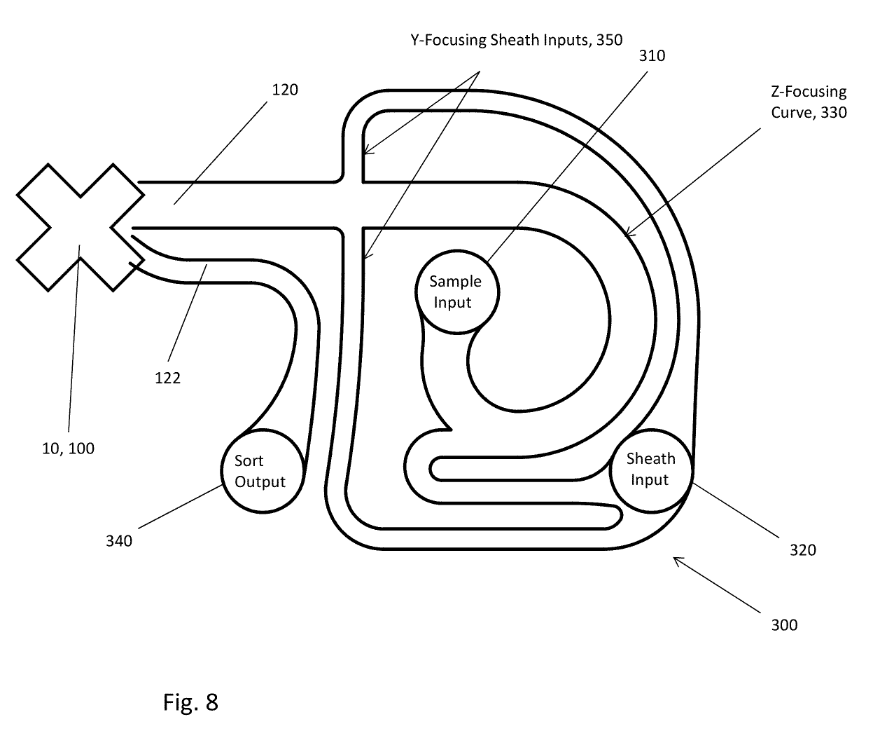

Because of the microfabricated nature of particle manipulation device 10 and 100, it lends itself to techniques that can make use of such an enclosed, well defined architecture. One such technique is illustrated in FIG. 8, wherein the microfabricated particle manipulation device may be coupled to a microfabricated fluidic focusing element 300. The focusing element 300 may include at least one additional sheath fluid inlet channel 320 that provides a sheath fluid to the sample stream and also a z-focusing curve 330 coupled to the sheath fluid inlet channel 320. The sheath fluid may be used to adjust the concentration or positioning of the target particles within the sample inlet channel. The focusing element 300 may be configured to urge the target particles into a particular portion of the sample inlet channel 120, such that the sorting process has fewer errors, as described further below. The focusing element 300 may be disposed in substantially the same plane as the movable member 110, and may be formed in the same substrate surface as the movable member 110 and sample inlet channel 120. The focusing element 300 may rely on inertial forces to focus the particles, as will be described further below. These forces may require relatively large flow rates to be effective. The microfabricated particle manipulation system with out-of-plane channel may be particularly suited to such an inertial focusing device, because of the narrow channels and high flow rates.

FIG. 8 depicts the microfabricated focusing element 300 which may be used to focus the particles in a certain area within the fluid stream. As the name suggests, the sheath fluid inlet channel 320 adds a sheath fluid to the sample stream, which is a buffering fluid which tends to dilute the flow of particles in the stream and locate them in a particular portion of the stream. The combined fluid then flows around a focusing element 300 coupled to the sample inlet channel 120. The focusing element 300 may include here a z-focusing curve 330, which tends to herd the particles into a particular plane within the flow. This plane is substantially in the plane of the paper of FIG. 8. The combined fluid in the focusing element 300 then passes another intersection point, a “y-intersection point” 350, which introduces additional sheath fluid above and below the plane of particles. At the y-intersection point 350, two flows may join the z-focus channel 330 from substantially antiparallel directions, and orthogonal to the z-focus channel 330. This intersection may compress the plane of particles into a single point, substantially in the center of the stream. Accordingly, at the y-intersection point 350 the target particles may be compressed from a plane to a stream line near the center of the z-focus channel 330 and sample inlet channel 120. Focusing the particles into a certain volume tends to decrease the uncertainly in their location, and thus the uncertainty in the timing of the opening and closing of the movable member or valve 110. Such hydrodynamic focusing may therefore improve the speed and/or accuracy of the sorting operation.

In one exemplary embodiment of the microfabricated particle manipulation device 10 or 100 with hydrodynamic focusing illustrated in FIG. 8, the angular sweep of z-bend 330 is a curved arc of about 180 degrees. That is, the approximate angular sweep between the junction of the sheath fluid inlet channel 320 and the y-intersection point 350, may be about 180 degrees. Generally, the radius of curvature of the z-bend 330 may be at least about 100 microns and less than about 500 microns, and the characteristic dimension, that is the width, of the channels is typically about 50 microns to provide the focusing effect. In one embodiment, the radius of curvature of the channel may be about 250 microns, and the channel widths, or characteristic dimensions, for the sample inlet channel 120 and z-bend channel 330 are on the order of about 50 microns. These characteristic dimensions may provide a curvature sufficient to focus the particles, such that they tend to be confined to the plane of the paper upon exit from the z-focus channel 330 at y-intersection point 350. This plane is then compressed to a point in the channel at the y-intersection point 350. Accordingly, the y-intersection 350 flows along with the z-focusing element 330 may urge the particles into a single stream line near the center of the microfabricated sample inlet channel 120.

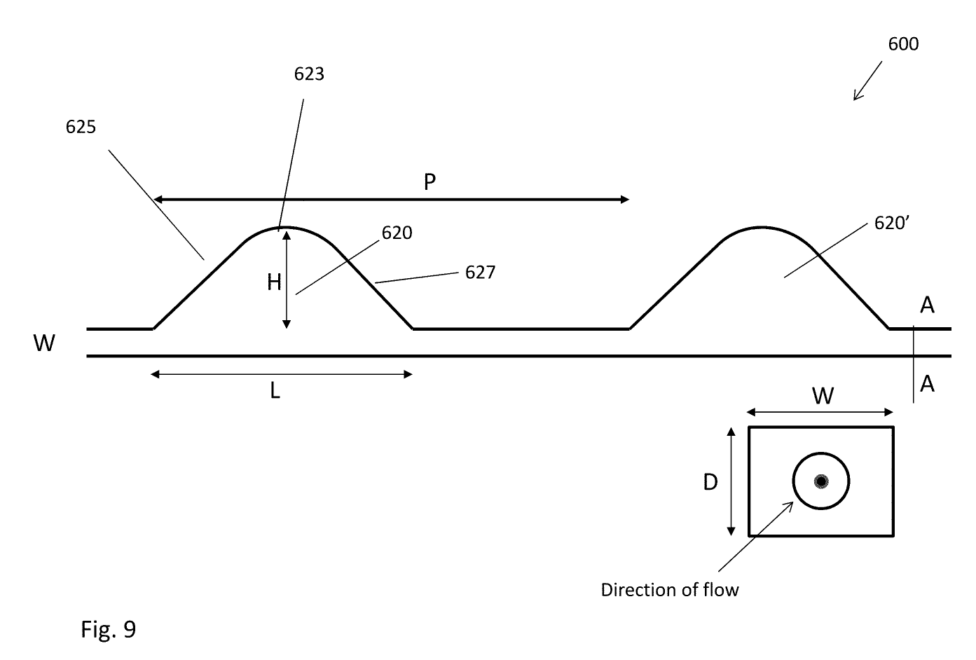

FIG. 9 shows another embodiment of a focusing element, 600. In this embodiment, the focusing element 600 includes a plurality of segments having a variable lateral dimension or cross section. The variable cross section portion of the channel serves to urge or focus the particles into a particular portion of the stream flowing in the channel. The discussion now turns to the design and performance details of this variable cross section focusing channel as applied to the above described microfabricated particle sorter 10, 100.

The novel flow channel may possess portions of variable cross section, wherein the variable cross section arises from the shapes of the sidewalls of the flow channel. These variable portions may have one sidewall which is substantially straight with respect to the flow direction, and an adjacent side wall which is not straight, or at least not parallel to the substantially straight portion. In particular, this adjacent sidewall may be triangular or parabolic in shape, deviating away from the straight sidewall in an expanding region, to a point of maximum channel width, before coming back to the nominal distance between the sidewalls in a contracting region. The expanding portion, maximum point, and contracting portion may constitute what is hereafter referred to as a fluid “cavity” 620 in the microfabricated channel. Accordingly, the variable channel width segments may define expansion/contraction cavities 620, 620′ within the microfluidic channel, wherein the cavity is defined by the expanding portion followed by the contracting portion.

The cavity 620 should be understood to be in fluid communication with the microfabricated fluid channel, such as sample inlet channel 120, such that fluid flows into and out of the cavity 620. It should be understood that this cavity 620 may be a two-dimensional widening of the channel in the expanding region, and narrowing of the channel in the contracting region. This shape of geometry is shown schematically in FIG. 9.

The variable cross section focusing channel 600 may be used instead of the curved focusing channel 300 shown in FIG. 8. That is, the variable crass section focusing channel 600 may be used in place of the z-focusing curve 330, or in place of the entire focusing element 300. The variable cross section focusing element 600 may be disposed upstream of the moveable member sorting device 110.

The cavity 620 may have a length of L, which may be the distance between the expanding and contracting portions. More particularly, the variable cross section portion, cavity 620, may have an expanding region 625 and a contracting region 627 disposed over a distance L with a high point 623 between them. The high point 623 may be the point of maximum lateral extent of the channel 600, that is, the portion of widest channel width. As shown in FIG. 9, the variable cross section focusing channel 600 may include a plurality of expanding and contracting regions, such as 620 and 620′ shown in FIG. 9. The expanding and contracting regions may be arranged in different ways with respect to a turn that is made by the channel as it directs the sample fluid from the sample input 310 to the valve mechanism 10 or 110.

Because of this shape, and expanding region 625 followed by a contracting region 627, the variable cross section focusing channel 600 may encourage various eddies, motions and hydrodynamic forces within the focusing element.

FIG. 9 illustrates quantities that will used to discuss the various design parameters and their resulting hydrodynamic behaviors in further detail below. H is the height of the variable cross section portion cavity, and L is the length of the cavity portion. W is the nominal width of the sample inlet channel 120 (channel without the expanding and contracting cavities). H/W is the aspect ratio of the variable cross section cavity portion with respect to the nominal channel width. The pitch P is the distance between one cavity 620 and a subsequent cavity 620′.

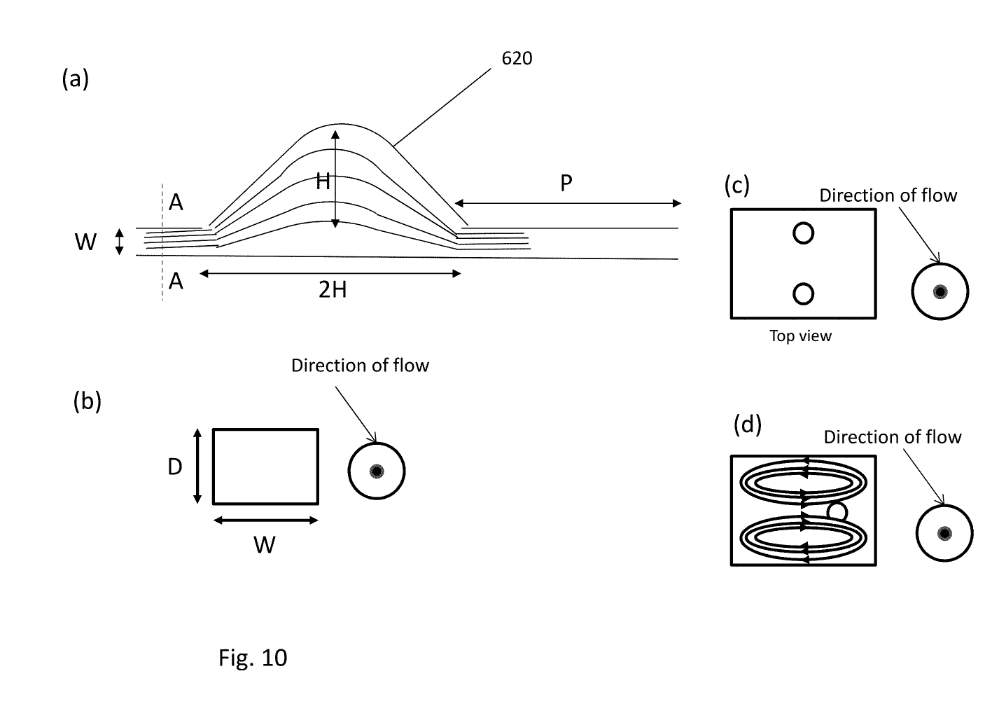

As mentioned previously, various hydrodynamic effects may result from this variable cross section geometry, and these are illustrated in FIG. 10. These effects may result in a geometry induced secondary flow focusing. Particles experience two forces in the flow. The first may be an inertial lift force, which is a combination of shear gradient lift resulting from the flow profile parabolic nature, and wall lift force. In addition, the particles may experience Dean flow drag: which is the drag force exerted on the particle as a result of the secondary dean flow induced by curved streamlines. It is possible to balance these two forces by proper selection of the geometrical parameters of height, size, aspect ratio and placement. Accordingly, these two forces may be balanced by introduction of the expansion-contraction cavities 620 of a particular size, shape and distribution, in the variable cross section element 600. The combination of geometrical parameters determines whether there is a balance between these forces or not and where in the channel are the equilibrium nodes or points where the net force on the particles is zero.

As a result of these balanced forces, particles may be focused in one position within the channel using the cavities 620, 620′ shown in FIG. 9, as the particles are brought to a two dimensional focused state.

FIG. 10 is simplified schematic diagram of the forces operating in the novel variable cross section focusing channel; (a) shows the contours of the device and the streamlines therein; (b) shows the cross sectional dimensions and the flow direction; (c) shows the stable regions (equilibrium nodes) in the flow channel without cavities; and (d) shows the hydrodynamic forces acting on the particles as a result of curved streamlines in the cavities;

As shown in FIG. 10(a), the cavities 620 in focusing element 600 are generally triangular cavities with a height of H and a base of 2H. In other words, the cavities may be two adjacently placed equilateral triangles. The width, W, of the nominal channel before and after the cavities 620 and 620′, is used as a scale factor, to parametrize the quantities as discussed below. The apex of the triangle may be smoothed to discourage bubbles becoming trapped at the apex.

The cross section of the channel is shown in (b) along with the flow direction in the channel. The inertial focusing effects are shown in FIG. 10(c). An equilibrium position exists for particles in a straight channel with the same non-varying cross section. The expansion-contraction cavities create an out of plane secondary flow (dean flow) which balances the inertial drag force and changes the equilibrium nodes, as shown in (d). Accordingly, an equilibrium position for the particles will exist as shown in FIG. 10, as shown in (c).

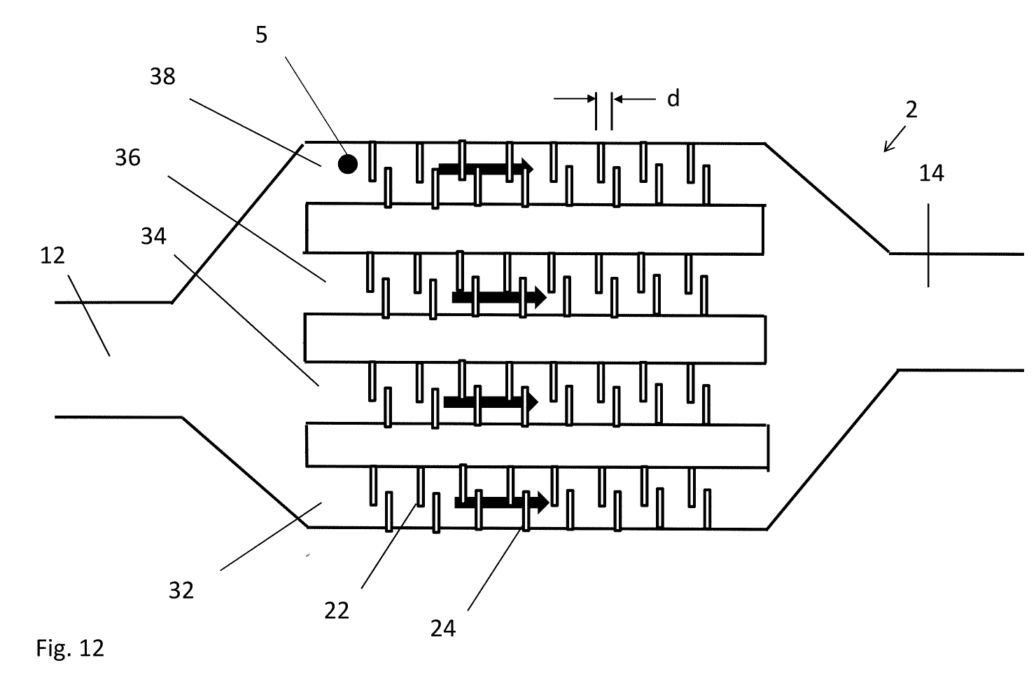

A filter element may be added for the purpose of retaining undesired particles, and placed upstream of the hydrodynamic focusing elements and the movable member 110 of the valve. FIG. 12 shows one such device, with parallel filter elements to allow more filter area and also robustness to filter clogging.

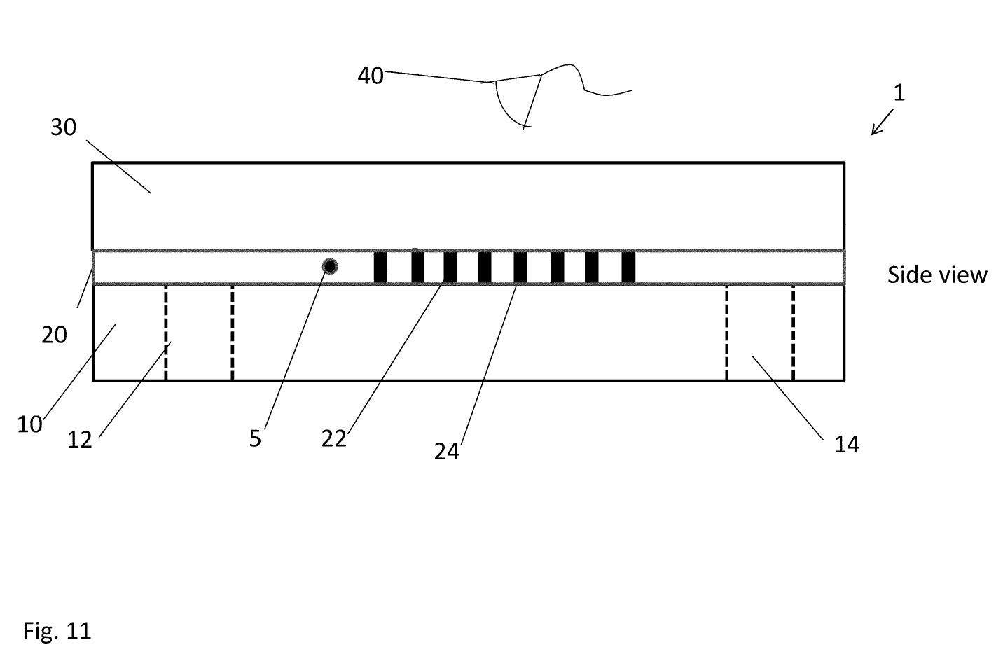

FIG. 11 is a cross sectional illustration of a microfabricated filter. The filter may be used in, for example, a cell sorting system as described below. In FIG. 11, a sample stream may include at least one debris particle 5, suspended therein. The sample stream may be admitted to the filter structure 1 through an inlet channel 12, from which it may flow laterally across the face of the substrate 10 as shown by the arrows in FIG. 12. The flow may traverse a series of filter barriers 22, 24 which are arranged so as not to seal the channel to the flow of the sample stream, but to trap particles of a particular size which may be suspended in the sample stream. In FIGS. 17 and 18, these filter barriers may be disposed in a staggered arrangement across the width of the channel. However, no barriers extend entirely across the channel so as to seal it against the flow. Instead, the sample stream may flow between the staggered barriers 22 and 24 which may be separated by a distance d. Accordingly, particulate debris with a dimension greater than d may be trapped in the filter 1.

As shown in FIG. 11, the microfabricated channel with filter barriers 22, 24 may be sealed on top by another layer or substrate 30. This layer or substrate 30 may be optically transparent, allowing radiation to pass through and impinge upon the trapped particle 5. The transparent layer 30 may comprise at least one of quartz, sapphire, zirconium, ceramic, and glass. The transparent layer 30 may allow analysis and characterization of the particulate debris found in the sample stream. Such information may be important in identifying and correcting the source of the contamination. FIG. 11 shows evaluation of trapped particle 5 by an analysis unit 40, such as a microscope or spectrometer. The analysis technique may include investigation of specular, diffractive, refractive behaviors of the particle 5, for example. Accordingly, the filter system may include an optical microscope which is disposed adjacent to the filter and is configured to image the particulates intercepted by the plurality of barriers, through the transparent layer 30. Alternatively, the analysis tool may be a spectrometer which is disposed adjacent to the filter and is configured to analyze the particulates intercepted by the plurality of barriers, through the transparent layer. In other embodiments, x-ray diffraction, crystallography, or other methods may be used to analyze the trapped debris through the transparently layer 30.

FIG. 12 is a plan view of the microfabricated filter 2. FIG. 12 shows effectively the staggered arrangement of the filter barriers 22 and 24. In one embodiment, each filter barrier 22 extends less than the full diameter, but more than one-half of the diameter of the channel. Accordingly, by staggering pairs of like filter barriers 22, 24 one behind the other, the channel remains open to the passing of the sample stream but will trap particles of debris with a dimension larger than the distance between the barriers. In other embodiments, the filter barriers 22, 24 may extend less than ½the distance across the channel, such that the fluid may flow between the barriers but particulate debris may not. Accordingly, in some embodiments, at least one of the plurality of barriers has a rectangular shape, and there is a varying distance between opposing barriers.

The plan view of FIG. 12 shows a plurality of parallel paths 32, 34, 36 and 38 each with filter barriers 24, 26. It should be understood that although the paths 32, 34, 36 and 38 may have the same shape of filter barriers 24, 26 as shown, or they may be different. In some embodiments, the filter barriers may be the same in the parallel paths 32, 34, 36 and 38. In other embodiments, the filter barriers may be different. The paths are shown as being in parallel, but this is also exemplary only, and some filter barrier shapes 32, 34, 36 and 38 may be placed serially before or after other filter barrier shapes. It should be appreciated that since the filter barriers are fabricated lithographically, the shapes may be made arbitrarily complex.

The sample stream may again be input to the filter 2 through an input channel 12, from which it may flow laterally across the face of the substrate 10 as shown by the arrows in. 32-38. The flow may traverse a series of filter barriers 22, 24 in each of the channels 3-38, which are arranged so as not to seal the channel to the flow of the sample stream, but to trap particles of a particular size which may be suspended in the sample stream. In channels 32-38, these filter barriers may be disposed in a staggered arrangement across the width of the channel. However, no barriers extend entirely across the channel so as to seal it against the flow. Instead, the sample stream may flow between the staggered barriers 22 and 24 which may be separated by a distance d. Accordingly, particulate debris with a dimension greater than d may be trapped in the filter barriers 22, 24.

In channels 32-38, the filter barriers may be simple rectangles, similar to filter barriers 22, 24 in FIGS. 11 and 12. In other embodiments, the barriers may have different shapes, such as a tapered shape, narrowing from base to tip, triangular or sawtooth. The filter barriers 34 may lean into or away from the flow. The different shapes and orientations may have different behaviors in terms of effectiveness in trapping particles. Each type of filter shape creates a specific flow circulation around it which traps particles based on their characteristics such as the relative rigidity or stiffness of the particle, or how round or rod-shaped a particle is.

The description now turns to the fabrication of the devices shown in FIGS. 1-12. Fabrication may first begin with the formation of a waste orifice 140 in a first silicon substrate 720. This may be simply the formation of a through hole using deep reactive ion etching (DRIE) for example. Alternatively, the holes 140 may be drilled in a substrate 720. In one embodiment, the waster orifice 140 may be formed in the handle layer of an silicon-on-insulator substrate.

Fabrication may then turn to the formation of the movable valves, 10, or 100. To make these structures, one may begin with formation of the inlaid permeable features 116 and 130 formed in a substrate 730. The permeable material 116 and 130 may be inlaid into a trench or depression prepared in the substrate 730 for this purpose. The substrate may be a single crystal silicon substrate or a silicon-on-insulator substrate 730, for example. To form these trenches, the depressions may be formed in these areas of the substrate surface by etching. First, photoresist may be deposited over the substrate surface 730 and removed over the areas corresponding to 116 and 130. Then, the trenches may be formed by, for example, etching the substrate in potassium hydroxide (KOH) to form a suitable depression or trench. A seed layer may then be deposited conformally over the first substrate surface and the depression, and patterned to provide the seed layer for plating NiFe into the trenches. The seed layer may be, for example, Ti/W or Cr/Au and may be deposited by sputtering, CVD or plasma deposition. This layer may then be covered with photoresist and patterned according to the desired shape of the areas 116 and 130. Unwanted areas of photoresist and seed layer may then be removed by chemical etching. The permeable features 116 and 10 may then be deposited over the patterned seed layer by sputtering, plasma deposition or electrochemical plating. It is known that permalloy (80% Ni and 20% Fe), for example, can readily be deposited by electroplating.

Alternatively, a liftoff method may be used to deposit a sheet of permeable material, most of which is then lifted off of areas other than 116 and 130. Further details into the lithographic formation of inlaid, magnetically permeable materials may be found in, for example, U.S. Pat. No. 7,229,838. U.S. Pat. No. 7,229,838 is hereby incorporated by reference in its entirety. The substrate may then be planarized by chemical mechanical polishing (CMP), leaving a flat surface for the later bonding of a cover plate, as described below.

Having made the permeable features 116 and 130, the movable member or valve 110 may be formed. The surface may again be covered with photoresist and patterned to protect the inlaid permeable features 116 and 130. The sample inlet channel 120 and output channels 122 may be formed simultaneously with the movable member 110. The movable member 110, and other areas whose topography is to be preserved, may be covered with photoresist. The features 110, 120, and 122 may then be formed by deep reactive ion etching (DRIE) for example. Accordingly, the sample inlet channel 120 and the sort channel 122 may be formed by DRIE into the substrate 730, at the same time as the movable member 110.

To enclose the fluidic channels, a cover plate may be bonded to the surface of the substrate 730 which was previously planarized for this purpose. Accordingly, with the addition of the transparent cover substrate 740 over the microchannels formed in the second substrate 730, the sample inlet channel 120 and sort channel 140 are now enclosed. The cover plate may be an optically transparent material or substrate 740 which allows laser light to be applied to the particles in the fluid stream flowing in the sample inlet channel 120, and for fluorescence emitted by the fluorescent tags affixed to the particles to be detected by the optical detection system described above.

Additional details for carrying out this process outlined above are well known to those skilled in the art, or readily found in numerous lithographic processing references. This procedure may yield the particle sorting devices 700 using substrates 720, 730 and 740.

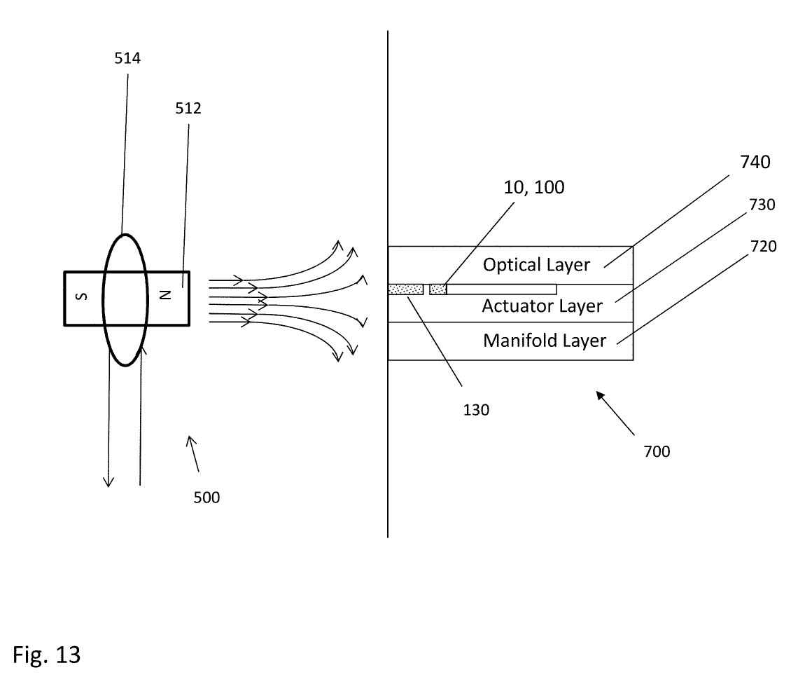

FIG. 13 also shows, for context, the relative placement of the electromagnet 500, outside of the wafer stack 720, 730 and 740. The electromagnet may produce magnetic flux as shown, which interacts with the stationary permeable feature 130 and the inlaid permeable feature 116.

Accordingly, as shown in FIG. 13 and described above, the fabrication of the devices 700 may require three substrates, a first substrate 720 which has the waste manifold 140 formed therein, an SOI wafer 730 on which the movable member 110 is formed, and an overlying transparent substrate 740 which encloses the microchannels but allows radiation to pass. Henceforth, and the silicon substrate 720 is referred to as the “first” substrate, the SOI wafer 730 is referred to as the “second, interior substrate” 730, and the transparent substrate as the third substrate 740.

Having completed the fabrication of the individual devices on the three substrates 720, 730 and 740 as described above, the process finally requires the individual devices 700 to be separated from the fabrication substrates. As is well known in semiconductor integrated circuit (IC) as well as microelectromechanical systems manufacturing techniques, a plurality of devices may be formed on a suitable wafer in a batch processing fashion. In the case of the particle sorting valve 10 or 100, a plurality of like or similar valves may be formed on a wafer stack 720, 730 an 740, as set forth above. Thus, upon completion of this process, a plurality of finished devices may be disposed on a wafer stack. The stack may include the first silicon wafer 720, the second interior substrate 730 and the upper transparent substrate 740. The situation is shown in FIG. 13.

To separate the individual devices, the plurality must be separated by singulating the wafer stack, that is, dicing or otherwise separating the individual devices by cutting or dicing the wafer stack consisting of the first silicon substrate 720, the second, interior substrate 730 and the upper transparent substrate 740.

It is known how to separate a wafer pair by application of focused laser radiation. For example, U.S. Pat. No. 8,785,234 issued Jul. 22, 2014 and incorporated by reference, describes such a procedure. In this process, a laser beam is directed onto the substrate and scanned along the dicing line such that defect regions are introduced into the substrate. During the multiple scans of the laser beam along the dicing lines the defect regions are inscribed at different depths of the wafer by focusing the laser beam at the different depths. Due to the defect regions arranged along the dicing lines in different depths a predetermined breaking point is generated. This technique is known as “stealth dicing” using a submerged dicing trench. The die can then be singulated by applying a shock or by mounting the stressed substrate onto an expandable carrier. This singulating method enables an improved rate of yield of the wafer due to the smaller cut-off at the scribeline and reduced chipping compared to wafer sawing.

In this and other laser-assisted processes, an infrared laser such as a Nd:YAG laser operating at 1.06 microns, may be focused by a lens at a particular depth in the substrate to be cleaved. The focused, powerful radiation may produce intense heat in a localized area. The heat may cause a defect as described above or even shatter the material or the crystalline structure of the substrate locally, in the focal spot. Upon causing this damage, the laser spot may be shifted laterally to a new spot along and within the substrate. By successively shifting the focal spot laterally, a perimeter line of shattered or damaged substrate material may be formed around the device.

The focusing element may then be shifted in the orthogonal dimension, that results in the raising or lowering the depth at which the focus damages the substrate material. The perimeter is then inscribed again, but this time at a slightly different depth or elevation. Upon completion of this new perimeter line, the depth is changed again, until the perimeter line of shattered or damaged material has been formed in a perimeter throughout the thickness of the substrate. This process may be analogous to scribing a line in a glass or ceramic material, for example.

A sharp but mild shock to the substrate pair may then separate the devices along the shatter lines that form the perimeters around the devices.

However, in the wafer stack shown in FIG. 13, and as described in the device fabrication process described above, there are three substrates rather than two required for the manufacture of this device. Between any two substrates is a material boundary which may alter the light, and/or the presence of adhesive bonding material that my refract, reflect or absorb the radiation. In any event, the boundary between the plural substrates will significantly affect the transmission of the radiation and the effectiveness of the scribing. Accordingly, the laser dicing techniques described above will not work to separate the devices, because of the presence of the second, interior substrate 730. The bondline and material boundaries between the middle substrate 730 and the top 740 and bottom 720 substrates will affect the laser beam so profoundly, that the microshatters cannot be made reliably within the interior substrate 730.

The method described here allows the laser separation technique to be applied to a three-substrate wafer stack. The technique may also be applied to wafer stacks having four or more substrates adhered together.

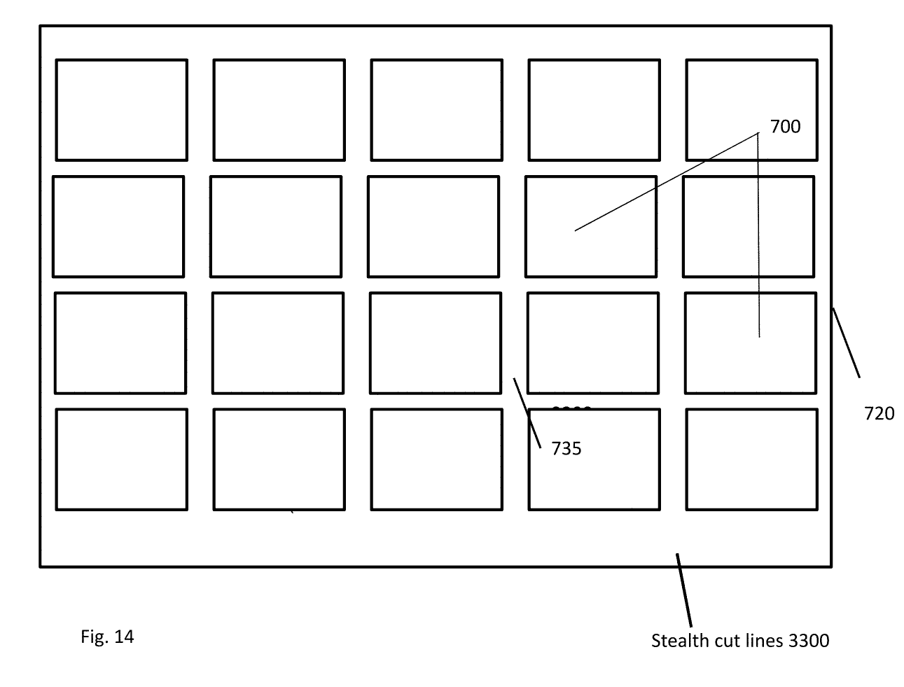

According to this method, the second interior substrate 730, here the SOI wafer, is patterned during the manufacturing process to remove the material on the interior substrate to form a perimeter void around the device 700. In other words, after bonding the SOI substrate 730 to the silicon substrate 720, a dicing or singulation “street” 735 is formed lithographically in the interior substrate prior to bonding to the third transparent substrate. The void or street may entirely surround the remaining device 700. The arrangement of the individual devices 700 surrounded by the voids or streets 735 is shown in the plan view of FIG. 14.

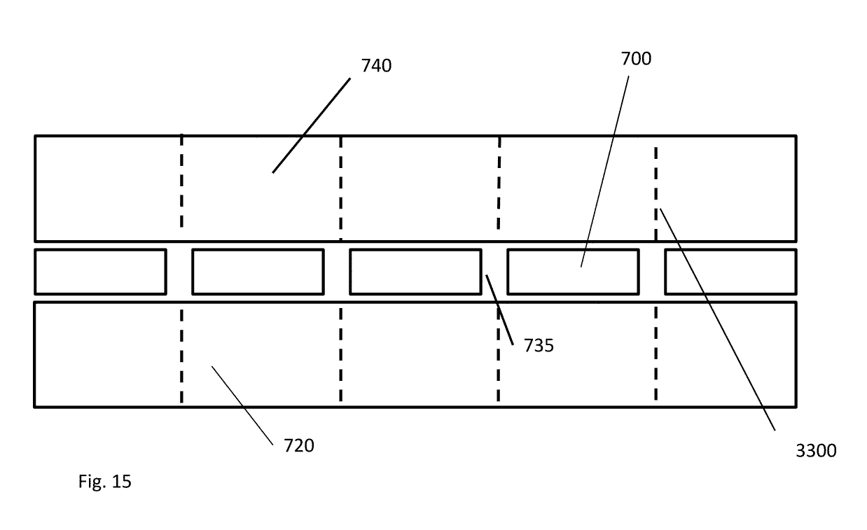

More particularly, in the appropriate step of the manufacturing process after the interior wafer 730 is bonded to the supporting substrate 720, a continuous perimeter void is formed around the device fabricated on the interior substrate 730. The wafer stack 720, 730 and 740 is shown in cross section in FIG. 15. FIG. 15 shows the individual devices, here these may be microfabricates particle sorting devices, 700, surrounded by streets or voids 735. This continuous perimeter void 735 may form a submerged dicing trench 735, which can be used in stealth dicing as described above.

The voids or streets 735 may be formed by deep reactive ion etching (DRIE). Other methods may be used to create the streets 735, including vacuum etching, and/or plasma etching, for example.

After fabrication of the devices 700 and streets 735, the devices may be separated as described above, by focusing IR radiation at points along the scribe lines 3300. The streets between devices may be from 700 microns to 1200 microns apart from each other. An infrared laser such as a Nd:YAG laser operating at 1.06 microns, may be focused by a lens at a particular depth in the substrate to be cleaved. The laser may have a power output of 0.15 W, and this radiation may be focused with a lens having a focal distance of about 1 cm. As before, the focused radiation may cause a defect as described above or even shatter the material or the crystalline structure of the substrate locally, in the focal spot. Upon causing this damage, the laser spot may be shifted laterally to a new spot along and within the substrate.

The focusing element may then be shifted in the orthogonal dimension, that results in the raising or lowering the depth at which the focus damages the substrate material. The perimeter is then inscribed again, but this time at a slightly different depth or elevation. Upon completion of this new perimeter line, the depth is changed again, until the perimeter line of shattered or damaged material has been formed in a perimeter throughout the thickness of the substrate. By successively shifting the focal spot laterally and then again in the z-dimension, a perimeter line (stealth dicing line) 3300 of shattered or damaged substrate material may be formed around the device 700, as shown in FIG. 15.

Because the second, interior substrate has already been separated during the fabrication process as described above, a sharp but mild shock to the wafer stack 720, 730 and 740 may then separate the devices along the stealth shatter lines 3300 that form the perimeters around the devices 700.

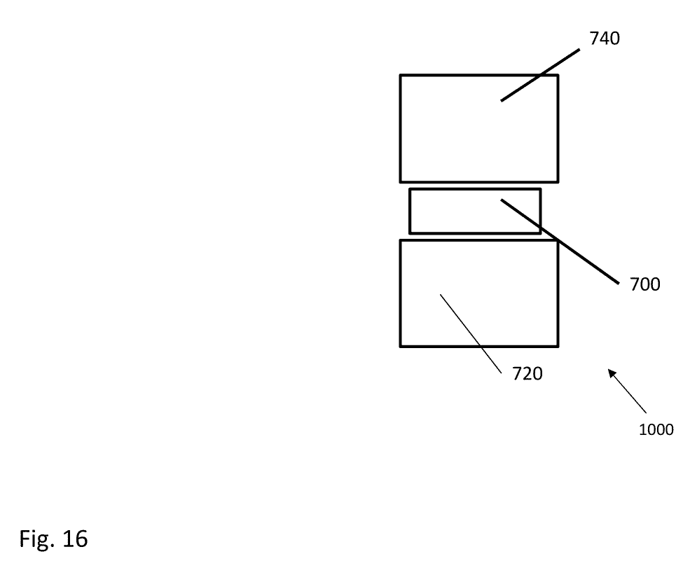

FIG. 16 shows the completed device 1000. Device 1000 comprises a transparent top layer 740, a valve or device layer 700 which supports the movable member 10, 100, and a lower silicon substrate layer 720 that may contain the waste manifold. The devices 700 may then be packaged for shipping or incorporated into a larger system, as described for example, in the incorporated applications U.S. Ser. No. 15/159,942, filed May. 20, 2016, which is a continuation of U.S. patent application Ser. No. 13/998,096.

Accordingly, disclosed here is a micromechanical device, formed on a wafer stack, the wafer stack having two outer substrates and at least one inner substrate. The micromechanical device may include a microfabricated structure formed on at least the one inner substrate, wherein the microfabricated structure is surrounded by a continuous void in the at least one inner substrate, and two outer substrates adhered to the inner substrate, the perimeter of the two outer substrates overhanging and extending beyond the void in the at least one inner substrate.

The at least one outer substrate may comprise silicon and the other outer substrate may comprise a transparent material, and the inner substrate may comprise a silicon-on-insulator substrate. The at least one outer substrate may comprise a silicon substrate, and the other outer substrate may be transparent, and may comprise at least one of glass, pyrex, alumina, silica and a ceramic, and the at least one inner substrate may comprise a silicon-on-insulator substrate. The microfabricated device may comprise at least one of a MEMS device and an integrated circuit. The microfabricated MEMS device may comprise at least one of a MEMS actuator, sensor, valve, motor and switch. The outer substrates may be adhered to the inner substrate by at least one of a metal thermocompression bond, a metal alloy bond, and a glass frit bond.

The microfabricated device may comprise a microfabricated valve formed on a surface of the substrate, wherein the microfabricated valve redirects the target particles into one of a plurality of output channels, based on a signal from the interrogation region, and wherein the motion of the microfabricated valve is substantially in a first plane parallel to the surface of the substrate; wherein the sample inlet channel is substantially also in the first plane parallel to the surface of the substrate, and wherein at least one of the output channels is in a second, different plane than the microfabricated valve and the sample inlet channel.

A method of forming a micromechanical device on a wafer stack the wafer stack having two outer substrates and at least one inner substrate is also disclosed. The method may include forming a microfabricated structure on the inner substrate, forming a void in the inner substrate completely surrounding the microfabricated structure, the void forming a perimeter around the microfabricated structure, and separating the individual microfabricated structures by dividing the outer substrates into die.

The method may further include adhering the at least one inner substrate to the two outer substrates using an adhesive, and wherein separating the individual microfabricated structures comprises separating the individual microfabricated structures by applying a shock to the wafer stack. Within the method, forming the void in the inner substrate completely surrounding the microfabricated structure may comprise forming a void with deep reactive ion etching completely around the microfabricated structure. The microfabricated structure may be a microfabricated valve formed on a surface of the substrate, wherein the microfabricated valve redirects the target particles into one of a plurality of output channels, based on a signal from the interrogation region, and wherein the motion of the microfabricated valve is substantially in a first plane parallel to the surface of the substrate; wherein the sample inlet channel is substantially also in the first plane parallel to the surface of the substrate, and wherein at least one of the output channels is in a second, different plane than the microfabricated valve and the sample inlet channel.

Within the method, separating the outer substrates into die may comprise forming a series of fractures in the outer substrates completely surrounding the microfabricated structure and overlapping the void formed in the inner substrate. Forming the series of fractures in the outer substrates may comprise focusing an infrared laser on the outer substrates, to fracture the material with heat. Focusing an infrared laser may comprise focusing a Nd:YAG laser on the outer substrates. One outer substrate may comprise silicon and the other outer substrate may comprise a transparent material.

Also disclosed is a wafer stack having two outer substrates and at least one inner substrate. The wafer stack may further include a plurality of microfabricated structures on the inner substrate, a plurality of voids in the inner substrate completely surrounding the microfabricated structures, forming a perimeter void around each of the microfabricated structures, and two outer substrates adhered to the inner substrate with microfabricated structure and void, wherein the two outer substrates overhang the voids in the inner substrate. Within the wafer stack, at least one outer substrate may comprise silicon and the inner substrate comprises a silicon-on-insulator substrate, and the other outer substrate is transparent and comprises at least one of glass, pyrex, alumina, silica and a ceramic.

Within the wafer stack, the microfabricated structures may comprise at least one of a MEMS device and an integrated circuit. The microfabricated MEMS device may comprise at least one of a MEMS actuator, sensor, valve, motor and switch. The microfabricated structures may comprise a microfabricated valve formed on a surface of the substrate, wherein the microfabricated valve redirects the target particles into one of a plurality of output channels, based on a signal from the interrogation region, and wherein the motion of the microfabricated valve is substantially in a first plane parallel to the surface of the substrate; wherein the sample inlet channel is substantially also in the first plane parallel to the surface of the substrate, and wherein at least one of the output channels is in a second, different plane than the microfabricated valve and the sample inlet channel.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting

What is claimed is:

1. A micromechanical device, formed on a wafer stack, the wafer stack
having two outer substrates and at least one inner substrate, comprising:
a microfabricated structure formed on at least the one inner substrate, wherein the microfabricated structure is surrounded by a continuous void in the at least one inner substrate;
and two outer substrates adhered to the inner substrate, the perimeter of the two outer substrates overhanging and extending beyond the void in the at least one inner substrate.

2. The micromechanical device of claim 1, wherein at least one outer substrate comprises silicon and the other outer substrate comprises a transparent material, and wherein the inner substrate comprises a silicon-on-insulator substrate.

3. The micromechanical device of claim 1, wherein at least one outer substrate comprises a silicon substrate, and the other outer substrate is transparent, and comprises at least one of glass, pyrex, alumina, silica and a ceramic, and the at least one inner substrate comprises a silicon-on-insulator substrate.

4. The micromechanical device of claim 1, wherein the microfabricated structure comprises at least one of a microfabricated MEMS device and an integrated circuit.

5. The micromechanical device of claim 4, wherein the microfabricated MEMS device comprises at least one of a MEMS actuator, sensor, valve, motor and switch.

6. The micromechanical device of claim 1, wherein the outer substrates are adhered to the inner substrate by at least one of a metal thermocompression bond, a metal alloy bond, and a glass frit bond.

7. The micromechanical device of claim 1, wherein the microfabricated device comprises a microfabricated valve formed on a surface of the substrate, wherein the microfabricated valve redirects the target particles into one of a plurality of output channels, based on a signal from the interrogation region, and wherein the motion of the microfabricated valve is substantially in a first plane parallel to the surface of the substrate; wherein the sample inlet channel is substantially also in the first plane parallel to the surface of the substrate, and wherein at least one of the output channels is in a second, different plane than the microfabricated valve and the sample inlet channel.

8. A method of forming a micromechanical device on a wafer stack the wafer stack having two outer substrates and at least one inner substrate, comprising:
forming a microfabricated structure on the inner substrate;
forming a void in the inner substrate completely surrounding the microfabricated structure, the void forming a perimeter around the microfabricated structure;
separating the individual microfabricated structures by dividing the outer substrates into die.

9. The method of claim 8, further comprising:
adhering the at least one inner substrate to the two outer substrates using an adhesive;
and wherein separating the individual microfabricated structures comprises separating the individual microfabricated structures by applying a shock to the wafer stack.

10. The method of claim 8, wherein forming the void in the inner substrate completely surrounding the microfabricated structure comprises forming a void with deep reactive ion etching completely around the microfabricated structure.

11. The method of claim 8, wherein the microfabricated structure is a microfabricated valve formed on a surface of the substrate, wherein the microfabricated valve redirects the target particles into one of a plurality of output channels, based on a signal from the interrogation region, and wherein the motion of the microfabricated valve is substantially in a first plane parallel to the surface of the substrate; wherein the sample inlet channel is substantially also in the first plane parallel to the surface of the substrate, and wherein at least one of the output channels is in a second, different plane than the microfabricated valve and the sample inlet channel.

12. The method of claim 8, wherein separating the outer substrates into die comprises:
forming a series of fractures in the outer substrates completely surrounding the microfabricated structure and overlapping the void formed in the inner substrate

13. The method of claim 8, wherein forming the series of fractures in the outer substrates comprises focusing an infrared laser on the outer substrates, to fracture the material with heat.

14. The method of claim 14, wherein focusing an infrared laser comprises focusing a Nd:YAG laser on the outer substrates.

15. The method of claim 14, wherein one outer substrate comprises silicon and the other outer substrate comprises a transparent material.

16. A wafer stack having two outer substrates and at least one inner substrate comprising:
a plurality of microfabricated structures on the inner substrate;
a plurality of voids in the inner substrate completely surrounding the microfabricated structures, forming a perimeter void around each of the microfabricated structures; and
two outer substrates adhered to the inner substrate with microfabricated structure and void, wherein the two outer substrates overhang the voids in the inner substrate.

17. The wafer stack of claim 17, wherein at least one outer substrate comprises silicon and the inner substrate comprises a silicon-on-insulator substrate, and the other outer substrate is transparent and comprises at least one of glass, pyrex, alumina, silica and a ceramic.

18. The wafer stack of claim 17, wherein the microfabricated structures comprise at least one of a MEMS device and an integrated circuit.

19. The wafer stack of claim 19, wherein the microfabricated MEMS device comprises at least one of a MEMS actuator, sensor, valve, motor and switch.

20. The wafer stack of claim 17, wherein the microfabricated structures comprise a microfabricated valve formed on a surface of the substrate, wherein the microfabricated valve redirects the target particles into one of a plurality of output channels, based on a signal from the interrogation region, and wherein the motion of the microfabricated valve is substantially in a first plane parallel to the surface of the substrate; wherein the sample inlet channel is substantially also in the first plane parallel to the surface of the substrate, and wherein at least one of the output channels is in a second, different plane than the microfabricated valve and the sample inlet channel.
